(19) United States
(12) Patent Application Publication
(10) Pub. No.: US 2022/0259344 A1
(43) Pub. Date: Aug. 18, 2022

(54) USE OF VINYL ACETATE COPOLYMERS AS A LOW-PROFILE ADDITIVE

(71) Applicant: Wacker Chemie AG, Munich (DE)

(72) Inventors: Markus Bannwarth, Burghausen (DE); Michael Tobias Zarka, Altötting (DE)

(73) Assignee: Wacker Chemie AG, Munich (DE)

(21) Appl. No.: 17/610,737

(22) PCT Filed: May 15, 2019
(86) PCT No.: PCT/EP2019/062531

§ 371 Date: Nov. 12, 2021

(51) Int. Cl. C08F 218/08; C08L 67/06

(52) U.S. Cl. CPC C08F 218/08; C08L 67/06

(57) ABSTRACT

A low profile additive includes vinyl acetate-isopropenyl acetate copolymers. The vinyl acetate-isopropenyl acetate copolymers are based on from 2 to 98% by weight of vinyl acetate, from 2 to 98% by weight of isopropenyl acetate and optionally one or more further ethylenically unsaturated monomers, in each case based on the total weight of the vinyl acetate-isopropenyl acetate copolymers.

The invention relates to the use of vinyl acetate copolymers as low profile additive (LPA), free-radically crosslinkable polymer compositions containing the abovementioned low profile additives and also the composite components obtainable therefrom.

Free-radically crosslinkable polymer compositions based on, for example, unsaturated polyester resins (UP resins) are frequently used for the production of composite components. Unsaturated polyester resins are generally polycondensates of dicarboxylic acid (anhydride)s with polyols. Further constituents of the free-radically crosslinkable polymer compositions are usually ethylenically unsaturated monomers such as styrene or methacrylate monomers in order to dissolve the crosslinkable polymer and convert the free-radically crosslinkable polymer composition into a flowable mass. To initiate the crosslinking of the polymer compositions, it is possible to use, for example, peroxides or hydroperoxides as initiators. Furthermore, the free-radically crosslinkable polymer compositions can optionally also contain fiber materials such as glass fibers, carbon fibers, natural fibers or corresponding fiber mats (Fiber Reinforced Plastic composite=FRP composite) which lead to a reinforcement of the composite components obtainable by curing of the free-radically crosslinkable polymer compositions. Free-radically crosslinkable polymer compositions can also be used, for example, for producing filled solid surface or engineered stone products—composite materials composed of unsaturated polyester resins or acrylate resins and mineral fillers such as silica or aluminum trihydrate (ATH).

One problem associated with the processing of free-radically crosslinkable polymer compositions to give composite components, in particular reinforced or filled components or materials, is the volume shrinkage during curing of the polymer composition. To reduce the shrinkage during curing, shrinkage-reducing additives, known as low profile additives (LPA), are therefore added to the free-radically crosslinkable polymer compositions. Low profile additives reduce the shrinkage during curing, dissipate residual stresses, decrease microcrack formation and assist adherence to manufacturing tolerances. In addition, a desirable aspect is that the low profile additives additionally improve the surface qualities of the composite components (in particular, class A surfaces should be achieved) and the impression of the reinforcing fibers on the component surface (“fiber print through”) should also be suppressed.

As low profile additives, use is frequently made of thermoplastics such as polystyrene, polymethyl methacrylate, saturated polyesters or polyvinyl acetate. Low profile additives based on polyvinyl acetate and optionally carboxyl-functional monomers are described, for example, in DE-A 2163089, U.S. Pat. No. 3,718,714 A or WO 2007/125035 A1. Polyvinyl acetates display significantly lower shrinkage values and significantly better surface quality of the components compared to polystyrene and polymethyl methacrylate, and significantly better mechanical properties compared to saturated polyester LPAs.

A further problem is that low profile additives can have an adverse effect on the static mechanical properties, for example bending and tensile strengths, of the cured composite component. To reduce this effect, it is advantageous for the low profile additives to display their shrinkage-reducing effect to the desired extent at very small added amounts. For this reason, there is a need for low profile additives which have a stronger shrinkage-reducing effect and allow the same shrinkage control at a lower added amount or make a lower shrinkage and better surface qualities of the component possible at the same added amount.

In order to increase the effectiveness of low profile additives, the addition of specific low-molecular weight compounds has been recommended. EP 0031434 recommends low molecular weight epoxidized compounds, e.g. epoxidized plasticizers, for this purpose. Such low molecular weight additives do not participate in curing and remain in the component and over the course of time can migrate from the component, which can lead to increased VOC values (VOC=volatile organic components) or FOG values (FOG=fogging; referring to outgassing of condensable substances) and impairment of the mechanical properties. Furthermore, such low molecular weight additives impair the blocking stability of the compositions, which makes logistics, transport and storage considerably more complicated and costly.

In the light of this background, it was an object of the invention to provide low profile additives (LPA) which efficiently counter the volume shrinkage in the course of curing of free-radically crosslinkable polymer compositions. If possible, adequate shrinkage control during curing should also be achieved when using relatively small amounts of LPA in free-radically crosslinkable polymer compositions. In addition, the LPA should preferably be blocking-stable. The addition of low molecular weight additives should be dispensed with if possible.

The object has surprisingly been achieved by use of copolymers containing particular amounts of isopropenyl acetate and vinyl acetate monomer units as LPA.

The invention provides for the use of vinyl acetate-isopropenyl acetate copolymers as low profile additive (LPA), characterized in that the vinyl acetate-isopropenyl acetate copolymers are based on from 2 to 98% by weight of vinyl acetate, from 2 to 98% by weight of isopropenyl acetate and optionally one or more further ethylenically unsaturated monomers, in each case based on the total weight of the vinyl acetate-isopropenyl acetate copolymers.

The vinyl acetate-isopropenyl acetate copolymers preferably comprise from 50 to 98% by weight, particularly preferably from 65 to 95% by weight and most preferably from 75 to 90% by weight, of vinyl acetate, based on the total weight of the vinyl acetate-isopropenyl acetate copolymers.

The vinyl acetate-isopropenyl acetate copolymers preferably comprise from 2 to 50% by weight, more preferably from 5 to 40% by weight, particularly preferably from 8 to 35% by weight and most preferably from 10 to 25% by weight, of isopropenyl acetate, based on the total weight of the vinyl acetate-isopropenyl acetate copolymers. Isopropenyl acetate is also referred to as 1-methylvinyl acetate.

Vinyl acetate and isopropenyl acetate are vinyl esters of acetic acid. The vinyl acetate-isopropenyl acetate copolymers preferably comprise >95% by weight, more preferably ≥96% by weight, even more preferably ≥98% by weight and particularly preferably ≥99% by weight, of vinyl esters of acetic acid, in particular vinyl acetate and isopropenyl acetate; based on the total weight of the vinyl esters copolymerized in the vinyl acetate-isopropenyl acetate copolymers; in particular based on the total weight of the vinyl acetate-isopropenyl acetate copolymers.

The further ethylenically unsaturated monomers are generally different from vinyl acetate and isopropenyl acetate.

Further ethylenically unsaturated monomers can be, for example, one or more vinyl esters other than vinyl acetate and isopropenyl acetate. Examples of such vinyl esters are vinyl propionate, vinyl butyrate, vinyl 2-ethylhexanoate, vinyl laurate, vinyl pivalate and vinyl esters of alpha-branched monocarboxylic acids having from 5 to 13 carbon atoms, for example VeoVa9R, VeoVa10R or VeoVa11R (tradenames of Shell). The vinyl acetate-isopropenyl acetate copolymers preferably comprise <5% by weight, more preferably <3% by weight and particularly preferably <1% by weight, of vinyl esters other than vinyl acetate and isopropenyl acetate, based on the total weight of the vinyl acetate-isopropenyl acetate copolymers. Vinyl acetate-isopropenyl acetate copolymers which do not contain any units of vinyl esters other than vinyl acetate and isopropenyl acetate are most preferred.

Preferred further ethylenically unsaturated monomers are ethylenically unsaturated acids or salts thereof, in particular carboxylic acids such as acrylic acid, methacrylic acid, crotonic acid, itaconic acid and fumaric acid, maleic acid, monoesters of fumaric acid or maleic acid or salts thereof, e.g. the ethyl and isopropyl esters; ethylenically unsaturated sulfonic acids or salts thereof, preferably vinylsulfonic acid, 2-acrylamido-2-methylpropanesulfonic acid; ethylenically unsaturated phosphonic acids or salts thereof, preferably vinylphosphonic acid. Particular preference is given to ethylenically unsaturated carboxylic acids or salts thereof. Acrylic acid, methacrylic acid, crotonic acid are most preferred. The vinyl acetate-isopropenyl acetate copolymers preferably comprise from 0 to 5% by weight, particularly preferably from 0.1 to 3% by weight and most preferably from 0.5 to 2% by weight, of ethylenically unsaturated acids or salts thereof, based on the total weight of the vinyl acetate-isopropenyl acetate copolymers.

Further examples of further ethylenically unsaturated monomers are one or more monomers selected from the group consisting of methacrylic esters or acrylic esters of carboxylic acids with unbranched or branched alcohols having from 1 to 15 carbon atoms, vinyl aromatics, vinyl halides, dienes and olefines. Such monomers are preferably copolymerized in an amount of <5% by weight, more preferably <3% by weight and particularly preferably ≤1% by weight, into the vinyl acetate-isopropenyl acetate copolymers, based on the total weight of the vinyl acetate-isopropenyl acetate copolymers. It is most preferred for no such monomers to be copolymerized into the vinyl acetate-isopropenyl acetate copolymers.

The vinyl acetate-isopropenyl acetate copolymers have glass transition temperatures Tg of preferably from 20 to 70° C., particularly preferably from 30 to 50° C. and most preferably from 35 to 45° C. The monomers and proportions by weight of the individual monomers are preferably selected so that the abovementioned glass transition temperatures Tg of the vinyl acetate-isopropenyl acetate copolymers are obtained. The glass transition temperature Tg can be determined in a known manner by means of differential scanning calorimetry (DSC). The Tg can also be calculated approximately beforehand by means of the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (% by weight/100) of the monomer n and Tgn is the glass transition temperature in Kelvin of the homopolymer of the monomer n. Tg values for homopolymers are reported in the Polymer Handbook 2nd Edition, J. Wiley & Sons, New York (1975).

The vinyl acetate-isopropenyl acetate copolymers have molecular weights Mw of preferably from 2000 to 750 000 g/mol, particularly preferably from 20 000 to 300 000 g/mol and most preferably from 50 000 to 200 000 g/mol (method of determination: SEC (“size exclusion chromatography”) using a polystyrene standard in THF at 60° C.).

The vinyl acetate-isopropenyl acetate copolymers have a Höppler viscosity of preferably from 1 to 100 mPas, particularly preferably from 2 to 20 mPas, even more preferably from 3 to 10 mPas and most preferably from 5 to 9 mPas (method of Höppler at 20° C., DIN 53015, in 10% strength solution in ethyl acetate).

The vinyl acetate-isopropenyl acetate copolymers are preferably not emulsifier-stabilized and/or preferably not protective colloid-stabilized.

The vinyl acetate-isopropenyl acetate copolymers are generally obtainable by polymerization of the ethylenically unsaturated monomers according to the invention in the presence of free radical initiators, in particular by means of free-radically initiated bulk, solution or suspension polymerization processes. The solution polymerization process is particularly preferred. In the solution polymerization process, an organic solvent or a mixture of organic solvents or a mixture of one or more organic solvents and water is preferably used as solvent. Preferred solvents are alcohols, ketones, esters, ethers, aliphatic hydrocarbons, aromatic hydrocarbons and water. Particularly preferred solvents are aliphatic alcohols having from 1 to 6 carbon atoms, e.g. methanol, ethanol, n-propanol or i-propanol, ketones such as acetone or methyl ethyl ketone, esters such as methyl acetate, ethyl acetate, propyl acetate or butyl acetate, or water. Methanol, i-propanol, methyl acetate, ethyl acetate and butyl acetate are most preferred.

The temperature in the polymerization is preferably from 20° C. to 160° C., particularly preferably from 40° C. to 140° C. In general, the polymerization is carried out at atmospheric pressure, preferably under reflux.

Suitable free radical initiators are, for example, oil-soluble initiators such as t-butyl peroxy-2-ethylhexanoate, t-butyl peroxypivalate, t-butyl peroxyneodecanoate, dibenzoyl peroxide, t-amyl peroxypivalate, di(2-ethylhexyl) peroxydicarbonate, 1,1-bis(t-butylperoxy)-3,3,5-trimethylcyclohexane and di(4-t-butylcyclohexyl) peroxydicarbonate. Azo initiators such as azobisisobutyronitrile are also suitable. The initiators are generally used in an amount of from 0.005 to 3.0% by weight, preferably from 0.01 to 1.5% by weight, in each case based on the total weight of the monomers for producing the vinyl acetate-isopropenyl acetate copolymers.

The polymerization rate can, for example, be controlled via the temperature, the initiators, by use of initiator accelerators or via the initiator concentration.

The setting of the molecular weight and of the degree of polymerization is known to a person skilled in the art. It can be effected, for example, by addition of chain transfer agents, by the ratio of solvent to monomers, by variation of the initiator concentration, by variation of the added amount of monomers and by variation of the polymerization temperature. Chain transfer agents are, for example, alcohols such as methanol, ethanol and isopropanol, aldehydes or ketones, e.g. acetaldehyde, propionaldehyde, butyraldehyde, acetone or methyl ethyl ketone, or else compounds containing mercapto groups, e.g. dodecyl mercaptane, mercaptopropionic acid or silicones containing mercapto groups.

The polymerization can be carried out with initial introduction of all or individual constituents of the reaction mixture, or with partial initial introduction and further feeding-in of all or individual constituents of the reaction mixture, or by the metering process without an initial charge.

Volatile residual monomers or further volatile constituents can be removed, for example, by means of distillation or stripping processes, preferably under reduced pressure.

The invention further provides free-radically crosslinkable polymer compositions containing

a) at least one crosslinkable unsaturated polyester resin (UP resin) or vinyl ester resin (VE resin),

b) at least one monomer having an ethylenically unsaturated group (reactive monomers),

c) at least one initiator, in particular peroxides or hydroperoxides,

d) optionally one or more accelerators such as cobalt- or amine-based accelerators,

e) optionally fiber materials,

f) optionally fillers, in particular mineral fillers, and

g) optionally additives, characterized in that one or more vinyl acetate-isopropenyl acetate copolymers according to the invention are additionally present.

The vinyl acetate-isopropenyl acetate copolymers function as LPA in the free-radically crosslinkable polymer compositions.

The free-radically crosslinkable polymer compositions contain the vinyl acetate-isopropenyl acetate copolymers in an amount of preferably from 2 to 20% by weight and particularly preferably from 4 to 16% by weight, based on the total weight of resin a) and monomer b) and vinyl acetate-isopropenyl acetate copolymer.

The vinyl acetate-isopropenyl acetate copolymers are generally used in the form of a 10-70% strength by weight solution, preferably 30-55% strength by weight solution, in ethylenically unsaturated monomers, preferably styrene or methacrylates such as methyl methacrylate (MMA), 1,3-butanediol dimethacrylate (1,3-BDDMA) and 1,4-butanediol dimethacrylate (1,4-BDDMA). The vinyl acetate-isopropenyl acetate copolymers are particularly preferably used as a 35-55% strength by weight solution in styrene, 1,4-BDDMA or 1,3-BDDMA.

To improve the mechanical strength after curing, it is possible to add from 1 to 20% by weight, based on vinyl acetate-isopropenyl acetate copolymer, of multifunctional acrylates or methacrylates such as trimethylolpropane trimethacrylate (TMPTMA) to the solutions.

The components a) to g) and the amounts used in the free-radically crosslinkable polymer compositions can in principle be selected in a conventional way by a person skilled in the art on the basis of the requirements of the respective application.

Unsaturated polyester resins (UP resins) suitable as resin a) are generally obtainable by polycondensation of unsaturated and saturated dicarboxylic acids or dicarboxylic anhydrides with polyols. Vinyl ester resins (VE resins) suitable as resin a) are, for example, obtainable by esterification of epoxy resins with acrylic acid or methacrylic acid. Suitable UP resins and VE resins are also commercially available.

The free-radically crosslinkable polymer compositions also contain monomers b) having ethylenically unsaturated groups, in general styrene or methacrylate monomers such as methyl methacrylate (MMA) or 1,3- and 1,4-butanediol dimethacrylate (1,3-BDDMA/1,4-BDDMA).

The addition of these monomers to the free-radically crosslinkable polymer compositions can, for example, serve to dissolve the crosslinkable resin a) or convert the free-radically crosslinkable polymer composition into a flowable mass.

The addition of the initiators c) to the free-radically crosslinkable polymer compositions generally serves to initiate the crosslinking of the unsaturated polyester or vinyl ester resin. It is possible to use customary peroxides or hydroperoxides in customary amounts, for example cumene hydroperoxide, dibenzoyl peroxide or methyl ethyl ketone peroxide.

The free-radically crosslinkable polymer compositions optionally also contain accelerators d). Accelerators d) can serve to accelerate the decomposition of the initiator. Suitable accelerators and amounts of them to be used are generally known to a person skilled in the art and are, for example, commercially available, for example cobalt salts, in particular cobalt octoate, cobalt neodecanoate or cobalt naphthenate. Preferred free-radically crosslinkable polymer compositions do not contain any accelerators d).

The free-radically crosslinkable polymer compositions can optionally contain fiber materials e) or fillers f) or additives such as processing aids, in particular thickeners.

Suitable fiber materials e) are, for example, glass fibers, carbon fibers, natural fibers or corresponding fiber mats (Fiber Reinforced Plastic composite=FRP composite).

Reinforcement of the composite components obtainable by curing of the free-radically crosslinkable polymer compositions can be achieved using such fiber materials.

The invention further provides composite components obtainable by curing the free-radically crosslinkable polymer compositions of the invention.

The curing of the free-radically crosslinkable polymer compositions is preferably carried out at temperatures of ≥40° C., particularly preferably from 60° C. to 180° C. and most preferably from 70 to 130° C. The curing is preferably carried out in the presence of one or more initiators by free-radically initiated polymerization. The free-radically crosslinkable polymer compositions are optionally pressed during curing at the respective temperature with application of pressures of ≥1 mbar, particularly preferably from 1 to 200 000 mbar and most preferably from 1000 to 200 000 mbar.

The composite components can be obtained from the free-radically crosslinkable polymer compositions by all customary production processes, for example by means of the sheet molding compound technology (SMC), bulk molding compound technology (BMC), resin transfer molding (RTM), pultrusion, continuous lamination or resin injection molding (RIM).

The free-radically crosslinkable polymer compositions of the invention can be processed by conventional processes known per se to give composite components.

When used as LPA in free-radically crosslinkable polymer compositions, the isopropenyl acetate-vinyl acetate copolymers according to the invention display a surprisingly strong shrinkage-reducing effect during the course of curing of the polymer compositions. This is the case even when only relatively small amounts of isopropenyl acetate-vinyl acetate copolymers are added to the free-radically crosslinkable polymer compositions. In addition, the LPA according to the invention are also surprisingly blocking-stable, even without addition of antiblocking agents such as carbonates, talc, gypsum, silica, kaolins or silicates. The LPAs according to the invention can advantageously also be pelletized and be provided in the form of blocking-stable pellets. All these effects were all the more surprising because isopropenyl acetate is structurally similar to vinyl acetate and the proportion according to the invention of isopropenyl acetate units in the LPAs according to the invention nevertheless considerably increased the LPA efficiency thereof.

The following examples serve to illustrate the invention further, without restricting the invention in any way.

### Production of Vinyl Acetate-Isopropenyl Acetate Copolymers

### EXAMPLE 1

VAc-IPAc Copolymer Containing 5% of IPAc (LPA1):

712.5 g of vinyl acetate, 37.5 g of isopropenyl acetate and 450 g of methanol were placed in a stirred 21 glass pot equipped with anchor stirrer, reflux condenser and metering devices. The initial charge was subsequently heated to reflux under nitrogen at a stirrer speed of 200 rpm. After attainment of reflux, 11 g of the initiator PPV (t-butyl perpivalate, 75% strength solution in aliphatics) in 16.5 g of methanol were introduced over a period of 300 minutes. To reduce the viscosity, methanol was added at various times: 195 minutes after attainment of reflux 200 g and 90 minutes later another 200 g. After cooling, the copolymer obtained was dried.

The Höppler viscosity of the copolymer determined in accordance with DIN 53015 (10% in ethyl acetate at 20° C.) was 7.2 mPas, its number average molecular weight Mₙ was 24 700 g/mol, its weight average molecular weight M_{w} was 114.300 g/mol, determined by size exclusion chromatography in THF at 60° C. relative to polystyrene standards having a narrow size distribution. The glass transition temperature Tg of the copolymers (determined by means of differential scanning calorimetry (DSC)) was 38.7° C.

### EXAMPLE 2

VAc-IPAc Copolymer Containing 15% of IPAc (LPA2):

637.5 g of vinyl acetate, 112.5 g of isopropenyl acetate and 187.5 g of methanol were placed in a stirred 2 l glass pot equipped with anchor stirrer, reflux condenser and metering devices. The initial charge was subsequently heated to reflux under nitrogen at a stirrer speed of 200 rpm. After attainment of reflux, 11 g of the initiator PPV (t-butyl perpivalate, 75% strength solution in aliphatics) in 16.5 g of methanol were introduced over a period of 300 minutes. To reduce the viscosity, methanol was added at various times: 250 minutes after attainment of reflux 100 g, 45 minutes later 100 g, 85 minutes after 50 g, 20 minutes later 100 g and 25 minutes after 100 g. After cooling, the copolymer obtained was dried.

The Höppler viscosity of the copolymer determined in accordance with DIN 53015 (10% in ethyl acetate at 20° C.) was 8.7 mPas, its number average molecular weight Mₙ was 34 000 g/mol, its weight average molecular weight M_{w} was 143 100 g/mol, determined by size exclusion chromatography in THF at 60° C. relative to polystyrene standards having a narrow size distribution. The glass transition temperature Tg of the copolymers (determined by means of differential scanning calorimetry (DSC)) was 41.3° C.

### EXAMPLE 3

VAc-IPAc Copolymer Containing 30% of IPAc (LPA3):

622.4 g of vinyl acetate, 266.8 g of isopropenyl acetate and 44.5 g of methanol were placed in a stirred 2 l glass pot equipped with anchor stirrer, reflux condenser and metering devices. The initial charge was subsequently heated to reflux under nitrogen at a stirrer speed of 150 rpm. After attainment of reflux, 10.7 g of the initiator PPV (t-butyl perpivalate, 75% strength solution in aliphatics) in 16.1 g of methanol were introduced over a period of 390 minutes. If the viscosity increased greatly, the viscosity was decreased by intermittent addition of methanol (see examples 1 and 2). After cooling, the copolymer obtained was dried.

The Höppler viscosity of the copolymer determined in accordance with DIN 53015 (10% in ethyl acetate at 20° C.) was 6.3 mPas, its number average molecular weight Mₙ was 35 600 g/mol, its weight average molecular weight M_{w} was 117 100 g/mol, determined by size exclusion chromatography in THF at 60° C. relative to polystyrene standards having a narrow size distribution. The glass transition temperature Tg of the copolymers (determined by means of differential scanning calorimetry (DSC)) was 42.9° C.

### EXAMPLE 4

VAc-IPAc Copolymer Containing 30% of IPAc and Additionally 1% of Crotonic Acid (LPA4):

363.4 g of vinyl acetate, 158.0 g of isopropenyl acetate, 5.3 g of crotonic acid and 0.26 g of the initiator TBPEH (tert-butyl peroxy-2-ethylhexanoate) were placed in a stirred 21 glass pot equipped with anchor stirrer, reflux condenser and metering devices. The initial charge was subsequently heated to reflux under nitrogen at a stirrer speed of 200 rpm. After attainment of reflux, 4.9 g of the initiator PPV (t-butyl perpivalate, 75% strength solution in aliphatics) in 7.4 g of methanol were introduced over a period of 300 minutes. If the viscosity increased greatly, the viscosity was decreased by intermittent addition of methanol (see examples 1 and 2). After cooling, the copolymer obtained was dried.

The Höppler viscosity of the copolymer determined in accordance with DIN 53015 (10% in ethyl acetate at 20° C.) was 4.9 mPas, its number average molecular weight Mₙ was 26 000 g/mol, its weight average molecular weight M_{w} was 96 800 g/mol, determined by size exclusion chromatography in THF at 60° C. relative to polystyrene standards having a narrow size distribution. The glass transition temperature Tg of the copolymers (determined by means of differential scanning calorimetry (DSC)) was 46.0° C.

Testing of the Vinyl Acetate-Isopropenyl Acetate Copolymers as Shrinkage-Reducing Additive (LPA):

1) UP Resin Compositions Having a Low LPA Content and Curing at 120° C.:

A mixture was produced from the raw materials indicated in table 1 and briefly degassed. The density D_{V} of the degassed mixture was determined, and the mixture was then poured into a mold, cured at 120° C. for 2 hours and subsequently after-cured for 24 hours at room temperature. Finally, the density D_{H} of the cured shaped body was determined. The shrinkage was determined by comparison of the density D_{V} of the mixture before curing with the density D_{H} of the shaped body after curing using the formula shrinkage (%)=(D_{H}−D_{V}/D_{H})×100 (table 2). Negative values indicate that the shaped body after curing was larger than the original mold.

The determination of the density was carried out using the density measuring instrument DMA 38 (tradename of Anton Paar) at 23° C.

TABLE 1
crosslinkable polymer compositions:

| | | Parts by |
|---|---|---|
| Type | Raw material | weight |
| Palapreg ® P17-02* | UP resin (65.0% strength in styrene) | 80.0 |
| LPA | LPA (40% strength in styrene) | 20.0 |
| Curox ® I-200** | Peroxide | 0.4 |

*Palapreg ® 17-02: tradename of Aliancys;
**Curox ® I-200: tradename of United Initiators.

The following materials were used as low profile additives (LPA):

LPAV1 (comparative example): Vinnapas® B 100 SP (tradename of Wacker Chemie, vinyl acetate homopolymer, Mw=100 000 g/mol);

LPA1: example 1 (5% of IPAc);

LPA2: example 2 (15% of IPAc);

LPA3: example 3 (30% of IPAc);

LPA4: example 3 (30% of IPAc, 1% of crotonic acid);

LPAV2 (comparative example): Vinnapas® C 501 (tradename of Wacker Chemie, carboxylated polyvinyl acetate, Mw=135 000 g/mol).

It can be seen from table 2 that conventional LPAs (LPAV1) are not effective in this low concentration.

The VAc-IPAc copolymers LPA1, LPA2 and LPA3 according to the invention, on the other hand, display a significant shrinkage reduction at the same added amount, with the LPA effect increasing with increasing proportion of IPAc in the copolymer and a slight expansion even being observed from 30% of IPAc. The VAC-IPAc-crotonic acid terpolymer LPA4 according to the invention containing 30% of IPAc and 1% of crotonic acid likewise displays an excellent shrinkage compensation down to 0.4%.

TABLE 2
shrinkage of the shaped bodies:

| | Density D_{V} of the | Density D_{H} of the | |
|---|---|---|---|
| | mixture before curing | shaped body after curing | Shrinkage |
| LPA | [g/mm³] | [g/mm³] | [‰] |
| — | 1.111 | 1.208 | 8.0 |
| LPAV1 | 1.090 | 1.194 | 8.7 |
| LPA1 | 1.090 | 1.138 | 4.2 |
| LPA2 | 1.089 | 1.111 | 2.0 |
| LPA3 | 1.089 | 1.085 | −0.4 |
| LPA4 | 1.090 | 1.094 | 0.4 |

2) UP Resin Compositions Having a Moderate LPA Content and Curing at 120° C.:

A mixture was produced from the raw materials indicated in table 3 and briefly degassed. The density D_{V} of the degassed mixture was determined, and the mixture was then poured into a mold and cured at 120° C. for 2 hours and subsequently after-cured at room temperature for 24 hours. Finally, the density D_{H} of the cured shaped body was determined. The shrinkage was determined by comparison of the density Dᵥ of the mixture before curing with the density D_{H} of the shaped body after curing using the formula shrinkage (%)=(D_{H}−D_{V}/D_{H})×100 (table 4). Negative values indicate that the shaped body after curing was larger than the original mold. The determination of the density was carried out using the density measuring instrument DMA 38 (tradename of Anton Paar) at 23° C.

TABLE 3
crosslinkable polymer compositions:

| | | Parts by |
|---|---|---|
| Type | Raw material | weight |
| Palapreg ® P17-02* | UP resin (65.0% strength in styrene) | 75.0 |
| LPA | LPA (40% strength in styrene) | 25.0 |
| Curox ® I-200** | Peroxide | 0.4 |

*Palapreg ® 17-02: tradename of Aliancys;
**Curox ® I-200: tradename of United Initiators.

TABLE 4
shrinkage of the shaped bodies:

| | Density D_{V} of the | Density D_{H} of the | |
|---|---|---|---|
| | mixture before curing | shaped body after curing | Shrinkage |
| LPA | [g/mm³] | [g/mm³] | [‰] |
| LPAV1 | 1.085 | 1.126 | 3.6 |
| LPA1 | 1.084 | 1.097 | 1.2 |
| LPA2 | 1.084 | 1.065 | −1.8 |
| LPA3 | 1.084 | 1.038 | −4.4 |

It can be seen from table 4 that although the conventional LPA (LPAV1) is effective at a moderate LPA content, the VAc-IPAc copolymers LPA1, LPA2 and LPA3 according to the invention display a significantly improved shrinkage reduction or even a significant expansion.

The shrinkage decreases significantly or the volume increase rises significantly with increasing proportion of IPAc in the copolymer.

3) UP Resin Compositions Having a Moderate LPA Content and Curing at 80° C.:

A mixture was produced from the raw materials indicated in table 3 and briefly degassed. The density D_{V} of the degassed mixture was determined, and the mixture was then poured into a mold and cured at 80° C. for 2 hours and subsequently after-cured at room temperature for 24 hours. Finally, the density D_{H} of the cured shaped body was determined. The shrinkage was determined by comparison of the density Dᵥ of the mixture before curing with the density D_{H} of the shaped body after curing using the formula shrinkage (%)=(D_{H}−D_{V}/D_{H})×100 (table 5). Negative values indicate that the shaped body after curing was larger than the original mold.

The determination of the density was carried out using the density measuring instrument DMA 38 (tradename of Anton Paar) at 23° C.

It can be seen from table 5 that although the conventional LPA LPAV1 is effective at a moderate LPA content, the VAc-IPAc copolymers LPA1, LPA2 and LPA3 according to the invention display a significantly improved shrinkage reduction at 80° C., too. The effect of the LPA improves with increasing proportion of IPAc in the copolymer.

TABLE 5
shrinkage of the shaped bodies:

| | Density D_{V} of the | Density D_{H} of the | |
|---|---|---|---|
| | mixture before curing | shaped body after curing | Shrinkage |
| LPA | [g/mm³] | [g/mm³] | [‰] |
| LPAV1 | 1.085 | 1.150 | 5.7 |
| LPA1 | 1.084 | 1.105 | 1.9 |
| LPA2 | 1.084 | 1.099 | 1.4 |
| LPA3 | 1.084 | 1.088 | 0.4 |

4) Production of BMC Plates Using LPA4 and Curing at 160° C.:

The UP resin and all additives (see table 6) except for the glass fibers and the filler (calcium carbonate) were firstly premixed in a container for 2 minutes using a high-speed mixer (resin paste). In one step, this resin paste was premixed with the glass fibers and the calcium carbonate for 15 minutes in a small laboratory kneader.

The BMC (bulk molding compound) was then packed styrene-tight using suitable films and stored at 23° C. for 2 days (maturing time) and subsequently placed in a Wickert press (pressing conditions: 3 minutes, 160° C., 730 kN pressing force, 3 mm plate thickness).

The BMC plates obtained in this way were, after cooling to room temperature, tested as follows:
mechanical properties: determination of the flexural E modulus in accordance with DIN EN ISO 1425;
shrinkage values (linear shrinkage): determined by measurement and reported in percentage values.

The results of testing are shown in table 7.

TABLE 6
crosslinkable polymer composition:

| | BMC 1 | BMC 2 |
|---|---|---|
| | [parts by | [parts by |
| Components | weight] | weight] |
| Palapreg P 18-03** | 60 | 60 |
| Vinnapas ® C 501* (40% strength in | 40 | |
| styrene) | | |
| LPA4 (40% strength in styrene) | | 40 |
| Peroxide (Luperox P**) | 1.50 | 1.50 |
| Luvatol MK 35** | 3.0 | 3.0 |
| Calcium stearate (lubricant) | 4.0 | 4.0 |
| Omyacarb 2 GU | 270 | 270 |
| Hydroquinone | 0.06 | 0.06 |
| Owens Corning 152A-14C (8 mm length, | 42.10 | 42.10 |
| glass fibers) | | |

*Vinnapas ® C 501: tradename of Wacker Chemie, carboxylated polyvinyl acetate. Mw = 135 000 g/mol;
**Palapreg ® 18-03: tradename of Aliancys AG; Luperox ® P: tradename of Arkema; Luvatol ® MK 35: tradename of Lehmann&Voss.

BMC 2 containing the LPA4 according to the invention displays a better surface quality compared to BMC 1 containing the Vinnapas® C 501 which is not according to the invention, as shown by a higher gloss and lower long wave and short wave values. The linear shrinkage is also lower in the case of BMC 2. The flexural E modulus, a measure of the stiffness of the composite component, is somewhat improved in the case of BMC 2 according to the invention.

TABLE 7
testing results:

| BMC plate | BMC 1 | BMC 2 |
|---|---|---|
| Linear shrinkage [%] | 0.04 | 0.02 |
| Flexural E modulus [MPa] | 12 700 | 12 800 |
| Gloss ¹ | 81.6 | 93.7 |
| Long wave² | 2.3 | 1.9 |
| Short wave² | 13.5 | 9.8 |

¹ Determined using the measuring instrument Byk-Gardner micro-haze plus;
²Determined using the measuring instrument Byk-Gardner micro-wave scan.

1-10. (canceled)

11. A low profile additive, comprising:
vinyl acetate-isopropenyl acetate copolymers, wherein the vinyl acetate-isopropenyl acetate copolymers are based on from 2 to 98% by weight of vinyl acetate, from 2 to 98% by weight of isopropenyl acetate and optionally one or more further ethylenically unsaturated monomers, in each case based on the total weight of the vinyl acetate-isopropenyl acetate copolymers.

12. The low profile additive as claimed in claim 1, wherein the vinyl acetate-isopropenyl acetate copolymers comprise from 50 to 98% by weight of vinyl acetate, based on the total weight of the vinyl acetate-isopropenyl acetate copolymers.

13. The low profile additive as claimed in claim 1, wherein the vinyl acetate-isopropenyl acetate copolymers comprise from 2 to 50% by weight of isopropenyl acetate, based on the total weight of the vinyl acetate-isopropenyl acetate copolymers.

14. The low profile additive as claimed in claim 1, wherein the vinyl acetate-isopropenyl acetate copolymers comprise ≥95% by weight of vinyl acetate and isopropenyl acetate, based on the total weight of the vinyl acetate-isopropenyl acetate copolymers.

15. The low profile additive as claimed in claim 1, wherein the vinyl acetate-isopropenyl acetate copolymers comprise the one or more further ethylenically unsaturated monomers and the one or more further ethylenically unsaturated monomers are selected from the group consisting of ethylenically unsaturated carboxylic acids, ethylenically unsaturated sulfonic acids and ethylenically unsaturated phosphonic acids and the salts of the abovementioned acids.

16. The low profile additive as claimed in claim 1, wherein the vinyl acetate-isopropenyl acetate copolymers have glass transition temperatures Tg of from 20 to 70° C. as determined by differential scanning calorimetry.

17. The low profile additive as claimed in claim 1, wherein the vinyl acetate-isopropenyl acetate copolymers have molecular weights Mw of from 2000 to 750 000 g/mol as determined by means of size exclusion chromatography, using polystyrene standard, in THF, at 60° C.

18. The low profile additive as claimed in claim 1, wherein the vinyl acetate-isopropenyl acetate copolymers have a Höppler viscosity of from 1 to 100 mPas as determined by the method of Höppler, in accordance with DIN 53015, at 20° C., in 10% strength solution in ethyl acetate.

19. A free-radically crosslinkable polymer composition, containing:
a) at least one crosslinkable, unsaturated polyester resin or at least one vinyl ester resin;
b) at least one monomer having an ethylenically unsaturated group,
c) at least one initiator, characterized in that one or more vinyl acetate-isopropenyl acetate copolymers as claimed in claim 1 are additionally present.

20. A composite component obtainable by curing the free-radically crosslinkable polymer composition of claim 19.
